(19) United States
(12) Patent Application Publication
(10) Pub. No.: US 2024/0384087 A1
(43) Pub. Date: Nov. 21, 2024

(54) HEAT-CURABLE BIO-BASED CASTING COMPOSITION, MOLDING PRODUCED THEREFROM AND METHOD FOR PRODUCING SUCH A MOLDING

(71) Applicant: Schock GmbH, Regen (DE)

(72) Inventors: Vitaliy DATSYUK, Zwiesel (DE); Adam ORENDORZ, Zwiesel (DE); Oskar ACHATZ, Bischofsmais (DE)

(21) Appl. No.: 18/787,319

(22) Filed: Jul. 29, 2024

Related U.S. Application Data
(62) Division of application No. 17/029,119, filed on Sep. 23, 2020.

(30) Foreign Application Priority Data
Sep. 25, 2019 (DE) 10 2019 125 777.8

(51) Int. Cl. C08L 33/12; B29C 45/00; B29K 33/00; B29K 509/02; C08L 33/08; C08L 33/10

(52) U.S. Cl. CPC C08L 33/12; B29C 45/0001; C08L 33/08; C08L 33/10; B29K 2033/12; B29K 2509/02

(57) ABSTRACT

A molding produced from a heat-curable bio-based casting composition, including:
(a) one or more monofunctional and one or more polyfunctional acrylic and/or methacrylic biomonomers of vegetable or animal origin,
(b) one or more polymers or copolymers selected from among polyacrylates, polymethacrylates, polyols, polyesters derived from recycled material or of vegetable or animal origin,
(c) inorganic filler particles of natural origin,
   where the proportion of the monofunctional and polyfunctional acrylic and methacrylic biomonomer(s) is 10-40% by weight, the proportion of the polymer(s) or copolymer(s) is 1-16% by weight and the proportion of the inorganic filler particles is 44-89% by weight, wherein the polymerized composition has an impact strength of from 2-5 mJ/mm².

### CROSS-REFERENCE TO RELATED APPLICATIONS

The present application is a Divisional Application of U.S. patent application Ser. No. 17/029,119, filed Sep. 23, 2020, which claims priority of DE 10 2019 125 777.8, filed Sep. 25, 2019, the priority of these applications is hereby claimed and these applications are incorporated herein by reference.

### BACKGROUND OF THE INVENTION

The invention relates to a heat-curable bio-based casting composition suitable for producing a molding consisting of a polymer matrix formed from the polymerized casting composition with filler particles embedded therein. The invention further relates to a molding produced from such a casting composition, for example in the form of a kitchen sink, a wash basin, a work surface, a bathtub or a shower base or a work surface, where the polymerized casting composition forms a biocomposite material consisting of a polymer matrix with embedded filler particles.

The biocomposite material of the invention or the molding of the invention is produced by firstly dispersing inorganic filler particles in a solution of at least one bio(co)polymer in a mixture of monofunctional and polyfunctional biomonomers to produce the casting composition of the invention, after which the casting composition is injected into a mold, the hollow space of the mold is filled and the material is fixed in the shape of the hollow space by means of heat by heat-induced polymerization of the monofunctional biomonomers and heat-induced crosslinking of the polyfunctional biomonomers.

The production of kitchen sinks, for example, from a polymerized casting composition is known. Such a kitchen sink accordingly has a polymer matrix in which filler particles are embedded in order to set desired properties. The casting composition is produced using suitable crosslinkable polymers, with polymers of petrochemical origin, i.e. polymers based on petroleum, being used. Although the kitchen sinks produced in such a way display very good mechanical properties and are thermally stable over a wide temperature range, the use of such polymers is disadvantageous, not least for reasons of sustainability (environmental protection & conservation of resources).

### SUMMARY AND DETAILED DESCRIPTION OF THE INVENTION

The invention therefore addresses the problem of providing an improved casting composition.

To solve this problem, a heat-curable bio-based casting composition comprising:
(a) one or more monofunctional and one or more polyfunctional acrylic and methacrylic biomonomers of vegetable or animal origin,
(b) one or more polymers or copolymers selected from among polyacrylates, polymethacrylates, polyols, polyesters derived from recycled material or of vegetable or animal origin,
(c) inorganic filler particles of natural origin,
where the proportion of the monofunctional and polyfunctional acrylic and methacrylic biomonomer(s) is 10-40% by weight, the proportion of the polymer(s) or copolymer(s) is 1-16% by weight and the proportion of the inorganic filler particles is 44-89% by weight, is provided.

The casting composition of the invention is characterized by the fact that it consists largely, or even to an extent of 100%, of biological or natural materials, especially in respect of the crosslinking materials used. Thus, the monofunctional and polyfunctional acrylic and methacrylic biomonomers used according to the invention are exclusively of vegetable or animal origin. Thus, no petrochemically produced polymers are used here. A biomonomer is a monomer of a biopolymer. The term “polyfunctional” encompasses bifunctional, trifunctional and higher-functional biomonomers.

The polymers or copolymers used are preferably likewise purely of vegetable or animal origin, i.e. these materials are also not of petrochemical origin. However, it is also possible to use polymers or copolymers derived from recycled material as an alternative to the use of materials of vegetable/animal origin. Although such recycled material is usually of petrochemical origin, no fresh material is used but instead existing recycled material is reused, which is likewise advantageous from environmental points of view. Since the biomonomers together with the inorganic fillers used, which are likewise of natural origin, make up the major part on the polymer side, a large part of petrochemical-based materials used hitherto is replaced within the casting composition according to the invention by biomaterial in the form of the biomonomers even when using recycled material. Preference is naturally also given to using polymers and copolymers of purely vegetable or animal origin, so that in this case a casting composition consisting to an extent of 100% of natural materials is obtained, since, as described above, the fillers are also of purely natural origin. The molding produced from the casting composition of the invention is consequently a bio-molding which consists predominantly or preferably entirely of biological, i.e. natural, materials. The production of the bio-composites composed of the filler particles and the crosslinking materials, which are produced from renewable sources, reduces the consumption of petrochemically produced materials and thus the consumption of petroleum and has a positive effect on the environment.

Despite the use of predominantly or exclusively natural materials for producing the casting composition or the molding, i.e., for example, a kitchen sink, it has surprisingly been found that the molding displays very good, sometimes even better, mechanical properties, in particular in respect of the impact toughness or the scratch resistance, compared to a known casting composition produced from petrochemically derived crosslinking materials or such a molding.

The production of bio-composite moldings such as kitchen sinks, shower bases, bathtubs, wash basins and work surfaces from high-quality monofunctional and polyfunctional bioacrylate and biomethacrylate monomers makes it possible to combine high technical performance requirements with an increased bio-renewable carbon content (BRC) (proportion of renewable carbon or the bio-based carbon content) in products. There are many different bio-available sources for producing monofunctional and polyfunctional bioacrylate and biomethacrylate monomers, e.g. vegetable oil, animal fat, wood. A BRC in biomonomers of up to 90% can be achieved.

The molding composed of the bio-composite material consists of a mixture of the inorganic filler which is embedded by means of a crosslinking polymerization process of the monofunctional and polyfunctional biomonomers in the polymer matrix and achieves great sustainability by the use of renewable raw materials.

The weight ratio of monofunctional biomonomers to polyfunctional biomonomers should, according to the invention, be from 2:1 to 80:1, preferably from 4:1 to 70:1, in particular from 5:1 to 60:1.

It is possible to use a monofunctional biomonomer in the form of a bio-based acrylate. This can be selected from among n-butyl acrylate, methyl acrylate, ethyl acrylate, tert-butyl acrylate, isobutyl acrylate, isodecyl acrylate, dihydrodicyclopentadienyl acrylate, ethyl diglycol acrylate, heptadecyl acrylate, 4-hydroxybutyl acrylate, 2-hydroxyethyl acrylate, hydroxyethylcaprolactone acrylate, polycaprolactone acrylate, hydroxypropyl acrylate, lauryl acrylate, stearyl acrylate, tert-butyl acrylate, 2-(2-ethoxy) ethyl acrylate, tetrahydrofurfuryl acrylate, 2-phenoxyethyl acrylate, ethoxylated 4-phenyl acrylate, trimethylcyclohexyl acrylate, octyldecyl acrylate, tridecyl acrylate, ethoxylated 4-nonylphenol acrylate, isobornyl acrylate, cyclic trimethylolpropane formal acrylate, ethoxylated 4-lauryl acrylate, polyester acrylate, stearyl acrylate, hyperbranched polyester acrylate, melamine acrylate, silicone acrylate, epoxy acrylate.

Furthermore, it is possible to use a monofunctional biomonomer in the form of a bio-based methacrylate. This can be selected from among methyl methacrylate, ethyl methacrylate, n-butyl methacrylate, isobutyl methacrylate, tert-butyl methacrylate, behenyl methacrylate, ehenylpolyethylene glycol methacrylate, cyclohexyl methacrylate, isodecyl methacrylate, 2-ethylhexyl methacrylate, lauryl methacrylate, stearyl methacrylate, stearylpolyethylene glycol methacrylate, isotridecyl methacrylate, ureidomethacrylate, tetrahydrofurfuryl methacrylate, phenoxyethyl methacrylate, 3,3,5-trimethylcyclohexanol methacrylate, isobornyl methacrylate, methoxypolyethylene glycol methacrylate, glycidyl methacrylate, hexylethyl methacrylate, glycerol formal methacrylate, lauryltetradecyl methacrylate, C17,4-methacrylate.

A polyfunctional biomonomer can be used in the form of a bio-based acrylate. This can be selected from among 1,6-hexanediol diacrylate, polyethylene glycol diacrylate, tetraethylene glycol diacrylate, tripropylene glycol diacrylate, polybutadiene diacrylate, 3-methyl-1,5-pentanediol diacrylate, ethoxylated bisphenol A diacrylate, dipropylene glycol diacrylate, ethoxylated hexanediol diacrylate, 1,10-decanediol diacrylate, ester diol diacrylate, alkoxylated diacrylate, tricyclodecanedimethanol diacrylate, propoxylated neopentyl glycol diacrylate, pentaerythritol tetraacrylate, trimethylolpropane triacrylate, ditrimethylolpropane tetraacrylate, tris (2-hydroxyethyl) isocyanurate triacrylate, dipentaerythritol pentaacrylate, ethoxylated trimethylolpropane triacrylate, pentaerythritol triacrylate, propoxylated trimethylolpropane triacrylate, ethoxylated pentaerythritol tetraacrylate, propoxylated glyceryl triacrylate, aliphatic urethane diacrylate, aliphatic urethane hexaacrylate, aliphatic urethane triacrylate, aromatic urethane diacrylate, aromatic urethane triacrylate, aromatic urethane hexaacrylate, polyester hexaacrylate, epoxidized soybean oil diacrylate.

Furthermore, a polyfunctional biomonomer can be used in the form of a bio-based methacrylate. This can be selected from among triethylene glycol dimethacrylate, ethylene glycol dimethacrylate, polyethylene glycol dimethacrylate, 1,4-butanediol dimethacrylate, diethylene glycol dimethacrylate, 1,6-hexanediol dimethacrylate, 1,10-decanediol dimethacrylate, 1,3-butylene glycol dimethacrylate, ethoxylated bisphenol A dimethacrylate, tricyclodecanedimethanol dimethacrylate, trimethylolpropane trimethacrylate.

According to the invention, the weight ratio of monofunctional or polyfunctional acrylates and methacrylates to the polymer(s) or copolymer(s), in particular selected from among polyacrylates, polymethacrylates, polyols or polyesters, should be from 90:10 to 60:40, preferably from 85:15 to 70:30.

The inorganic filler particles, too, are of natural, i.e. biological, origin and not produced synthetically. They can be selected from among SiO₂, Al₂O₃, TiO₂, ZrO₂, Fe₂O₃, ZnO, Cr₂O₅, carbon, metals and metal alloys, with mixtures of two or more different types of filler particles also being able to be used. The mixing ratio can be as desired.

The inorganic filler particles should have a particle size of from 0.010 to 8000 μm, preferably from 0.05 to 3000 μm, and in particular from 0.1 to 1300 μm. Furthermore, the inorganic filler particles should have an aspect ratio of from 1.0 to 1000 (length: width of the individual particles).

For easy processability, the viscosity of the casting composition obtained should be set so that the casting composition can be injected under pressure by means of a suitable injection device into a mold so as to completely fill the mold cavity.

In addition to the casting composition, the invention provides a molding produced from the casting composition of the invention. Since the casting composition is effectively a bio-casting composition because it preferably consists to an extend of even 100% of natural, biological materials, this molding is consequently a bio-composite body, i.e., for example, a bio-composite kitchen sink or the like.

Different types of molding can be produced here. Thus, the molding can be a kitchen sink, a shower base, a wash basin, a bathtub, a work surface or a floor, wall or ceiling panel, with this enumeration not being exhaustive.

As stated above, it has been found that the moldings obtained have very good properties, in particular mechanical properties, despite the use of bio-based starting materials of which the casting composition consists. The polymerized bio-composite material of the molding should have an impact strength of from 2 to 5 mJ/mm² and also be thermally stable over the range from −30 to 300° C.

An above-described advantage of the invention is that the use of one, two or more monofunctional biomonomers makes it possible to vary the thermal, mechanical and surface properties of the end product, i.e. the finished molding, in accordance with product requirements. The impact toughness can, for example, be improved by addition of bio-lauryl methacrylate monomer having good flexibility.

The concentration of the bio-lauryl methacrylate in the bio-composite material is preferably from about 0.5 to about 10% by weight, in particular from 0.7 to 5.0% by weight. It has been found that a small amount of flexible bio-lauryl methacrylate leads to an improvement in the impact toughness.

A further advantage as described above of the invention is that the thermal stability of the finished molding can be improved by, for example, addition of bio-isobornyl methacrylate monomer having increased thermal stability.

The concentration of the bio-isobornyl methacrylate in the bio-composite material is preferably from about 1.0 to about 20% by weight, in particular from 2.0 to 17.0% by weight. It has been found that a small amount of bio-isobornyl methacrylate leads to an improvement in the scratch resistance.

A further advantage of the invention is that the aging resistance can, for example, be improved by addition of bio-isobornyl acrylate monomer having improved weather resistance. The concentration of the bio-isobornyl acrylate in the bio-composite material is preferably from about 1.0 to about 10% by weight, in particular from 2.0 to 7.0% by weight. It has been found that a small amount of bio-isobornyl acrylate leads to an improvement in the aging resistance.

A further advantage of the invention is that the chemical resistance is improved by, for example, addition of bio-(1,10-decanediol diacrylate) bifunctional monomer. The concentration of the bio-(1,10-decanediol diacrylate) in the bio-composite material is preferably from about 0.15 to about 10% by weight, in particular from 0.3 to 5.0% by weight. It has been found that a small amount of bio-(1,10-decanediol diacrylate) leads to an improvement in the chemical resistance.

A further advantage of the invention is that the filler dispersion is increased by, for example, addition of bio-(propoxylated (3) glyceryl triacrylate) trifunctional monomer because of very good wetting of fillers. The concentration of the bio-(propoxylated (3) glyceryl triacrylate) in the bio-composite material is preferably from about 0.1 to about 5% by weight, in particular from 0.3 to 2.0% by weight. It has been found that a small amount of bio-(propoxylated (3) glyceryl triacrylate) leads to an improvement in the distribution of filler in a matrix and to improved thermal and mechanical properties.

A further advantage of the invention is that the abrasion resistance of the bio-composite composition of the molded article can be improved by, for example, addition of bio-polyethylene glycol dimethacrylate bifunctional monomer having increased abrasion resistance. The concentration of the bio-polyethylene glycol dimethacrylate in the bio-composite material is preferably from about 0.1 to about 10% by weight, in particular from 0.3 to 5.0% by weight. It has been found that a small amount of bio-polyethylene glycol dimethacrylate leads to an improvement in the abrasion resistance.

A further advantage of the invention is that the scratch resistance of the molding can be improved by, for example, addition of bio-dipentaerythritol pentaacrylate polyfunctional monomer having increased scratch resistance. The concentration of the bio-dipentaerythritol pentaacrylate in the bio-composite material is preferably from about 0.1 to about 7% by weight, in particular from 0.3 to 5.0% by weight. It has been found that a small amount of bio-dipentaerythritol pentaacrylate leads to an improvement in the scratch resistance.

Inorganic fillers can be used in the form of SiO₂ in the form of quartz particles, cristobalite particles, pyrogenic silica particles, aerated silica particles, silica fibers, silica fibrils, silicate particles such as sheet silicates; Al₂O₃ particles, TiO₂ particles, Fe₂O₃ particles, ZnO particles, Cr₂O₅ particles, carbon black particles, carbon nanotube particles, graphite particles or graphene particles.

To obtain the excellent stable dispersion of the inorganic filler in the polymer matrix, the monomer mixture can contain a bio-based composition of polymers and/or copolymers from recycled or bio-based resources in order to set a suitable viscosity.

The invention also provides a method for producing a molding of the type described above, wherein a casting composition of the type which has likewise been described above is used and is introduced into a mold in which it polymerizes at a temperature above room temperature, after which the polymerized molding is taken from the mold and cools.

Here, the temperature during the polymerization should be 60-140° C., preferably 75-130° C. and in particular 80-110° C.

Furthermore, the hold time during which the casting composition remains in the mold in order to polymerize should be 15-50 min, preferably 20-45 min and in particular 25-35 min.

The production of the molding from the heat-curable bio-based casting composition is a multistage process which comprises the following:
production of polymer matrix components
dispersion of inorganic fillers in a polymer matrix
crosslinking polymerization of kitchen sinks, wash basins, bathtubs, work surfaces.

### EXAMPLES

A number of experimental examples to illustrate in more detail the casting composition of the invention, the molding of the invention and the method of the invention will be presented below.

### Example 1

Production of polymer matrix components from various monofunctional monomers

### Components Used:

(a) Monofunctional Biomonomers:

isobornyl methacrylate (IBOMA, Evonik Performance Materials GmbH), lauryl methacrylate (LMA, Arkema France), isobornyl acrylate (IBOA; Miwon Specialty Chemical Co., Ltd), glycerol formal methacrylate (GLYFOMA, Evonik Performance Materials GmbH), lauryl acrylate (LA, Arkema France), lauryltetradecyl methacrylate (LTDMA, Miwon Specialty Chemical Co., Ltd), C17,4-methacrylate (C17.4-MA, Evonik Performance Materials GmbH).

Components are all of vegetable or animal origin, for example VISIOMER® Terra IBOMA is produced from pine resin.
(b) Polymer:

Acrylglas-Feinmahlgut XP 85 (recycled PMMA (Kunststoff-und Farben-GmbH))
(c) Filler:

SiO2 [80% quartz particle size 0.06-0.3 mm (Dorfner GmbH); 20% quartz flour, particle size 0.1-0.70 μm (Quarzwerke GmbH) and TiO2 particles (Crystal International B.V.)]
(d) Additives:

Bio-based dispersing additives (0.1%) (BYK Chemie GmbH) and thixotropy additives (0.1%) (BYK Chemie GmbH)

The compositions for producing polymer matrices are produced by dissolving Acrylglas-Feinmahlgut XP 85 (recycled PMMA (Kunststoff-und Farben-GmbH)) in the mixture of monofunctional monomers of Table 1: isobornyl methacrylate (Evonik Performance Materials GmbH), lauryl methacrylate LMA (Arkema France), isobornyl acrylate (Miwon Specialty Chemical Co., Ltd), glycerol formal methacrylate (Evonik Performance Materials GmbH), lauryl acrylate (Arkema France), lauryl tetradecyl methacrylate (Miwon Specialty Chemical Co., Ltd), C17,4-methacrylate (Evonik Performance

Materials GmbH). The reaction mixture was heated at 40° C. in order to accelerate the solubility for 100 minutes until a clear solution had been obtained. To compare the matrix components, the compositions were prepared and are summarized in Table 1:

TABLE 1

| Monofunctional | Sample | Sample | Sample | Sample | Sample |
|---|---|---|---|---|---|
| biomonomers | 1 | 2 | 3 | 4 | 5 |
| Isobornyl methacrylate | 80 | | 45 | 50 | |
| Lauryl methacrylate | 20 | | | | 10 |
| Isobornyl acrylate | | 80 | 45 | 40 | 60 |
| Glycerol formal | | | | | 30 |
| methacrylate | | | | | |
| Lauryl acrylate | | | | 10 | |
| Lauryltetradecyl | | 20 | | | |
| methacrylate | | | | | |
| C17,4-Methacrylate | | | 10 | | |

All samples from Table 1 were used as solvent for Acrylglas-Feinmahlgut XP 85 in a ratio of 80:20 to increase the viscosity of the reaction mixture (from 120 to 155 cPs, Brookfield Viscometer DVI Prime) followed by addition of 20% by weight of bio-(1,10-decanediol diacrylate) (Arkema France).

The clear solution of Acrylglas-Feinmahlgut XP85 in samples 1-5 with addition of bio-(1,10-DDDA) was used for dispersing a mixture of inorganic fillers (70% by weight), which contained 95% by weight of SiO2 [80% quartz particle size 0.06-0.3 mm (Dorfner GmbH), 20% quartz flour, particle size 0.1-0.70 μm (Quarzwerke GmbH)] and 5% of TiO2 particles (Crystal International B.V.). Furthermore, a bio-based dispersing additive (0.1%) (BYK Chemie) and thixotropy additive (0.1%) (BYK Chemie) were added. The casting composition produced in this way was stirred for 20 minutes (Dispermat AE-3M, VMA-Getzmann GmbH). A molding in the form of a kitchen sink was produced from the casting composition by pouring the casting composition into a mold and polymerizing it at 110° C. for 35 minutes.

Mechanical and thermal properties of the kitchen sinks from samples 1-5.

TABLE 2

| | Sam- | Sam- | Sam- | Sam- | Sam- | Compar- |
|---|---|---|---|---|---|---|
| | ple | ple | ple | ple | ple | ative |
| Properties | 1 | 2 | 3 | 4 | 5 | sink |
| Impact toughness | 3.4 | 3.2 | 2.7 | 2.5 | 2.4 | 2.3 |
| mJ/mm² | | | | | | |
| Scratch resistance | + | + | + | + | + | + |
| Taber abrasion, μg | 17 | 19 | 16 | 11 | 14 | 12 |
| Heat resistance* | + | + | + | + | + | + |
| Temperature | + | + | + | + | + | + |
| change | | | | | | |
| resistance** | | | | | | |

For the impact toughness measurements, 12 samples having a size of 80 × 6 mm were cut from the sink. The measurements were carried out on a ZwickRoell HIT P instrument.
For the scratch resistance measurements, a sample (100 × 100 mm) was cut and the topography before and after scratching was measured (Mitutoyo Surftest SJ 500P).
For the Taber abrasion test, a sample (100 × 100 mm) was cut and an abrasion test was carried out on an Elcometer 1720.
*The method is based on the test method DIN EN 13310, in which the test piece having a temperature of 180° C. is placed in the middle of the kitchen sink for 20 minutes without leaving behind any visible changes on the surface of the sink.
**The method is based on the test method DIN EN 13310, in which the sink is treated with cold-hot water for 1000 cycles. Hot water, T = 90° C., flows for 90 seconds into the sink, followed by relaxation for 30 seconds, with further flowing cold water (T = 15° C.) for the next 90 seconds. The cycle is ended by a relaxation for 30 seconds.

The composite material for the comparative sink was produced using organic compounds of petrochemical origin as per the patent application DE 38 32 351 A1.

The table shows that all properties measured on experimental examples at least correspond to those of the known comparative sink which consists of non-bio-based components as far as the monomers and polymers are concerned, or in most cases are even better than for the comparative sink. The impact toughness in particular is sometimes significantly improved in the case of samples 1-4.

### Example 2

### Production of Polymer Matrix Components Comprising Various Polyfunctional Monomers

### Components Used:

(a) Monofunctional Biomonomers: IBOMA and LMA in a ratio of 80:20 of isobornyl methacrylate (IBOMA, Evonik

Performance Materials GmbH) and lauryl methacrylate (LMA, Arkema France)
(b) Polyfunctional Monomers

1,10-(Decanediol diacrylate), propoxylated (3) glyceryl triacrylate (Arkema France), polyethylene glycol dimethacrylate (Arkema France) and epoxidized soybean oil diacrylate (Miwon Specialty Chemical Co., Ltd)
(c) Polymer:

Methacrylate copolymer (Röhm GmbH)
(d) Filler:

SiO₂[80% quartz particle size 0.06-0.3 mm (Dorfner GmbH); 20% quartz flour, particle size 0.1-0.70 μm (Quarzwerke GmbH)] and TiO₂ particles (Crystal International B.V.)
(e) Additives:

Bio-based dispersing additive (0.1%) (BYK Chemie GmbH) and thixotropy additive (0.1%) (BYK Chemie GmbH)

The compositions for production of polymer matrices are produced by dissolving methacrylate copolymer (Rohm GmbH) in the mixture of monofunctional monomers IBOMA and LMA in a ratio of 80:20. The reaction mixture was heated at 40° C. in order to accelerate the solubility for 150 minutes, followed by addition of the polyfunctional monomers: 1,10 DDDA, propoxylated (3) glyceryl triacrylate (Arkema France), polyethylene glycol dimethacrylate (PEG-DMA, Arkema France), epoxidized soybean oil diacrylate (Miwon Specialty Chemical Co., Ltd), in order to finalize the composition for forming the polymer matrix. For comparison of the matrix components, the compositions were produced from various polyfunctional monomers and are summarized in Table 3. The concentration of the polyfunctional monomers is reported in % by weight of the amount of the monofunctional monomers:

TABLE 3

| | Sample | Sample | Sample | Sample |
|---|---|---|---|---|
| Polyfunctional biomonomers | 6 | 7 | 8 | 9 |
| 1,10-Decanediol diacrylate | 34 | 26 | 10 | |
| Propoxylated (3) glyceryl | 16 | | | |
| triacrylate | | | | |
| Polyethylene glycol dimethacrylate | | | | 10 |
| Epoxidized soybean oil diacrylate | | | 2 | 2 |

Mechanical and thermal properties of the kitchen sinks from samples 6-9

TABLE 4

| | Sample | Sample | Sample | Sample | Comparative |
|---|---|---|---|---|---|
| Properties | 6 | 7 | 8 | 9 | sink |
| Impact toughness | 3.3 | 2.9 | 3.2 | 2.7 | 2.3 |
| mJ/mm² | | | | | |
| Scratch resistance | + | + | + | + | + |
| Taber abrasion, μg | 17 | 19 | 15 | 15 | 12 |
| Heat resistance* | + | + | + | + | + |
| Temperature change | + | + | + | + | + |
| resistance** | | | | | |

The measured values in Table 4 show that even within these experimental examples, the moldings sometimes have considerably improved mechanical properties, particularly in respect of the impact toughness and the scratch resistance. That is to say, not only an environmentally advantageous improvement but also an improvement of, in particular, the mechanical properties of the moldings is achieved by the use of the bio-based starting materials.

### Example 3

### Production of Polymer Matrix Components Using Various Recycled Polymers or Biopolymers

### Components Used:

(a) Monofunctional Biomonomers:

IBOMA and LMA in a ratio of 80:20 isobornyl methacrylate (IBOMA, Evonik Performance Materials GmbH) and lauryl methacrylate (LMA, Arkema France)
(b) Polyfunctional Biomonomers: 20% by Weight of bio-(1,10-decanediol diacrylate) (Arkema France)
(c) Polymer:

Recycled polymers and/or biopolymers and/or biocopolymers: recycled PMMA (Kunststoff-und Farben-GmbH), poly-(3-hydroxybutyrate-co-3-hydroxyvalerate) (Ningbo Tianan Biologic Material Co. Ltd), castor oil polymer (D.O.G Deutsche Oelfabrik Ges. f. chem. Erz. mbH & Co.KG)
(d) Filler:

SiO₂ [80% quartz particle size 0.06-0.3 mm (Dorfner GmbH); 20% quartz flour, particle size 0.1-0.70 μm (Quarzwerke GmbH)] and TiO₂ particles (Crystal International B.V.)
(e) Additives:

Bio-based dispersing additive (0.1%) (BYK Chemie) and thixotropy additive (0.1%) (BYK Chemie)

The compositions for the production of polymer matrices are produced by dissolving recycled polymer and/or biopolymer and/or biocopolymer (recycled PMMA (Kunststoff-und Farben-GmbH), poly-(3-hydroxybutyrate-co-3-hydroxyvalerate) (Ningbo Tianan Biologic Material Co.Ltd), castor oil polymer (D.O.G Deutsche Oelfabrik Ges. f. chem. Erz. mbH & Co.KG)) in the mixture of monofunctional monomers IBOMA and LMA in a ratio of 80:20. The reaction mixture was heated at 40° C. in order to accelerate the solubility for 100 minutes, followed by the addition of PEG-DMA (10% by weight of the monofunctional monomers) and epoxidized soybean oil diacrylate (2% by weight of the monofunctional monomers) to finalize the composition for forming the polymer matrix. To compare the matrix components, the compositions were produced from various biopolymers and are summarized in Table 5. The concentration of the biopolymer is reported in % by weight of the amount of the monofunctional monomers:

TABLE 5

| Polymer | Sample 10 | Sample 11 | Sample 12 | Sample 13 |
|---|---|---|---|---|
| Recycled PMMA | 20 | 26 | | |
| Poly-(3-hydroxybutyrate- | | | 20 | 2 |
| co-3-hydroxyvalerate) | | | | |
| Castor oil polymer | | | | 25 |

Kitchen sinks were produced by the method described in Example 1.

Mechanical and thermal properties of the kitchen sinks from samples 10-13.

TABLE 6

| | Sample | Sample | Sample | Sample | Comparative |
|---|---|---|---|---|---|
| Properties | 10 | 11 | 12 | 13 | sink |
| Impact toughness | 3.0 | 2.9 | 2.7 | 2.3 | 2.3 |
| mJ/mm² | | | | | |
| Scratch resistance | + | + | + | + | + |
| Taber abrasion, μg | 17 | 15 | 16 | 18 | 12 |
| Heat resistance* | + | + | + | + | + |
| Temperature change | + | + | + | + | + |
| resistance** | | | | | |

### Example 4

### Preparation of the Molding Using Various Inorganic Fillers

### Components Used:

(a) Monofunctional Biomonomers:

IBOMA and LMA in a ratio of 80:20 isobornyl methacrylate (IBOMA, Evonik Performance Materials GmbH) and lauryl methacrylate (LMA, Arkema France)
(b) Polyfunctional Biomonomers:

PEG-DMA and epoxidized soybean oil diacrylate
(c) Polymer:

Recycled PMMA (Kunststoff-und Farben-GmbH)
(d) Filler:

Quartz, quartz flour, titanium dioxide, iron oxide, carbon black, graphite, aluminum hydroxide trihydrate
(e) Additives:

Bio-based dispersing additive (0.1%) (BYK Chemie GmbH) and thixotropy additive (0.1%) (BYK Chemie GmbH)

A mixture for polymer matrix formation is produced as described in Examples 1, 2, 3. 20% by weight of recycled PMMA (Kunststoff-und Farben-GmbH) is dissolved in the mixture (80: 20% by weight) of monofunctional monomers, IBOMA and LMA. The reaction mixture was heated at 40° C. in order to accelerate the solubility for 100 minutes, followed by the addition of the polyfunctional monomers, 10% by weight of PEG-DMA and 2% by weight of epoxidized soybean oil diacrylate, to conclude the composition for formation of the polymer matrix. For comparison, various inorganic fillers, which are summarized in Table 7, were added. Quartz particles were produced by Dorfner GmbH. Titanium dioxide particles were produced by Cristal International. Iron oxide particles were produced by Harold Scholz & Co GmbH. Natural carbon black particles (Orion Engineered Carbon GmbH), natural graphite were produced by RMC

Remacon GmbH. Aluminum hydroxide trihydrate (ATH) was produced by SHIJIAZHUANG CHENSHI IMPORT AND EXPORT CO. LTD.

TABLE 7

| | Sample | Sample | Sample | Sample |
|---|---|---|---|---|
| Filler | 14 | 15 | 16 | 17 |
| Quartz, particle size 0.06-0.3 mm | 52 | | 20 | 30 |
| Quartz, particle size 0.4-0.8 mm | | 55 | | |
| Quartz, particle size 0.9-1.3 mm | | | 20 | |
| Quartz flour, particle size | 13 | 10 | 10 | 5 |
| 0.1-0.70 μm | | | | |
| Titanium dioxide particles | 5 | | | |
| Iron oxide particles | | | | 5 |
| Carbon black particles | | 10 | | |
| Graphite | | | 20 | |
| Aluminum hydroxide trihydrate | | | | 30 |

The concentration of the biopolymer is reported in % by weight based on the total amount of the material.

TABLE 8

| | Sample | Sample | Sample | Sample | Comparative |
|---|---|---|---|---|---|
| Properties | 14 | 15 | 16 | 17 | sink |
| Impact toughness | 2.8 | 2.3 | 2.7 | 2.7 | 2.3 |
| mJ/mm² | | | | | |
| Scratch resistance | + | + | + | + | + |
| Taber abrasion, μg | 24 | 25 | 14 | | 12 |
| Heat resistance* | + | + | + | + | + |
| Temperature change | + | + | + | + | + |
| resistance** | | | | | |

Here too, the examples according to the invention which differ in terms of the fillers sometimes display considerably better measured values, in particular in respect of impact toughness and the scratch resistance and also abrasion, compared to the comparative molding.

### Example 8

Calculation of the bio-renewable carbon index (BCI) in casting compositions according to the invention

| | BRC, | Sample | Sample |
|---|---|---|---|
| Composition | % | 15 | 16 |
| IBOA, C₁₃H₂₀O₂ | 77 | 44 | 45 |
| LMA, C₁₆H₃₀O₂ | 75 | 10.73 | 11 |
| 1,10-DDDA, C₁₆H₂₆O₄ | 60 | 5.34 | 4.4 |
| Epoxidized soybean oil diacrylate, C₆₃H₁₀₈O₁₅ | 89 | 1.6 | 1.3 |
| THBV, (—OCH(CH₃)CH₂—CO)ₓ(OCH(C₂H₅)CH₂CO—)_{y} | 100 | 17.9 | 2 |
| Castor oil polymer, C₅₇H₁₀₄O₉ | 100 | | 25 |
| Total BCI, % | | 79.57 | 88.7 |

BCI for the sinks made from the petrochemical raw materials is 0.

The BCI of the chemical components is calculated according to the following formula:

$$BCI = 100 ⨯ ( BRC / C ) ,$$

where
BCI=bio-renewable carbon index in %
BRC=amount of bio-renewable carbon
C=total amount of carbon

For example: isobornyl acrylate (IBOA) has the formula: C₁₃H₂₀O₂

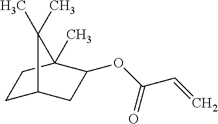

BRC=10
C=13

$$\to BCI = 100 ⨯ ( 10 / 13 ) = 7 6.9 \%$$

The total BCI for bio-composite material is calculated by calculation of the BRC in the composite, as a function of the BRC of each component of the composite.

For Example:

Sample 15 has the following composition or proportion in % in respect of the carbon-containing chemicals:

| | |
|---|---|
| IBOA - | 57.1 |
| LMA - | 14.3 |
| 1,10 DDDA - | 8.9 |
| eSojaölDA - | 1.8 |
| THBV - | 17.9 |
| Total | 100 |

The percentage chemical content is multiplied by the BCI content.

| | | |
|---|---|---|
| IBOA - | (57.1 × 77)/100 = | 44 |
| LMA - | (14.3 × 75)/100 = | 10.73 |
| 1,10 DDDA - | (8.9 × 60)/100 = | 5.34 |
| eSojaölDA - | (1.8 × 89)/100 = | 1.60 |
| THBV - | (17.9 × 100)/100 = | 17.9 |
| Total | | 79.57 |

The second characteristic which gives a picture of the content of renewable raw materials is the RRM value (renewable raw material, in % by weight).
RRM=weight of the renewable raw materials divided by the weight of the end product

The inorganic fillers used are derived 100% from renewable sources: sand particles, mineral particles, carbon black from burnt wood, graphite.

The example of the calculation of RRM for the organic phase is illustrated with the aid of Sample 15.

Sample 15 composed of the organic chemicals has a composition in %:

| | |
|---|---|
| IBOA - | 57.1 |
| LMA - | 14.3 |
| 1,10 DDDA - | 8.9 |
| eSojaölDA - | 1.8 |
| THBV - | 17.9 |
| Total | 100 |

Molecular weight for the chemicals is:

| | |
|---|---|
| IBOA - | 208 |
| LMA - | 254 |
| 1,10 DDDA - | 282 |
| eSojaölDA - | 1104 |
| THBV (repeating segment) - | 186 |

having a proportion by weight of renewable raw materials of:

| | |
|---|---|
| IBOA (C₁₁H₁₈O) - | 166 |
| LMA (C₁₃H₂₅O) - | 197 |
| 1,10 DDDA (C₁₂H₂₀O₂) - | 196 |
| eSoyaölDA (C₅₅H₁₀₈O₁₁) - | 944 |
| THBV | 186 |

The RRM value for the chemicals is:

| | |
|---|---|
| IBOA - | 100 × 166/208 = 79.8 |
| LMA - | 100 × 197/254 = 77.6 |
| 1,10 DDDA - | 100 × 196/282 = 69.5 |
| eSojaölDA - | 100 × 944/1104 = 85.5 |
| THBV (repeating segment) - | 100 × 186/186 = 100 |

The percentage chemical content is multiplied by the RRM value.

| | | |
|---|---|---|
| IBOA - | (57.1 × 79.8)/100 = | 45.57 |
| LMA - | (14.3 × 77.6)/100 = | 11.10 |
| 1,10 DDDA - | (8.9 × 69.5)/100 = | 6.19 |
| eSojaölDA - | (1.8 × 85.5)/100 = | 1.54 |
| THBV - | (17.9 × 100)/100 = | 17.9 |
| Total | | 82.3 |

The RRM value for the binder material is 82.3 (% by weight), while for the total sink the RRM value is 94.69 (% by weight).

$$R R M = ( 82.3 ⨯ 30 ) / 100 + ( 70 ⨯ 100 ) / 100 = 94.69 ( \% by weight )$$

In comparison thereto, the RRM value for sinks made from petrochemical raw materials is 66-69 (% by weight), since the inorganic filler particles used are of natural origin.

We claim:

1. A molding produced from a heat-curable bio-based casting composition, comprising:
(a) two or more monofunctional and one or more polyfunctional acrylic and/or methacrylic biomonomers of vegetable or animal origin,
(b) at least two polymers or copolymers of different type selected from polyacrylates, polymethacrylates, polyols, polyesters, wherein the at least two polymers or copolymers are derived from recycled material or of vegetable or animal origin, the at least two polymers or copolymers being solved in the mixture of the two or more monofunctional and the one or more polyfunctional biomonomers,
(c) inorganic filler particles of natural origin,
where the proportion of the two or more monofunctional and one or more polyfunctional acrylic and methacrylic biomonomer(s) is 10-40% by weight, the proportion of the at least two polymer(s) or copolymer(s) is 1-16% by weight and the proportion of the inorganic filler particles is 44-89% by weight, wherein the polymerized composition has an impact strength of from 2-5 mJ/mm².

2. The molding according to claim 1, wherein the weight ratio of two or more monofunctional biomonomers to the one or more polyfunctional biomonomers is from 2:1 to 80:1.

3. The molding according to claim 1, wherein the two or more monofunctional biomonomer(s) is/are selected from bio-based acrylates, wherein the bio-based acrylates are selected from the group consisting of: n-butyl acrylate, methyl acrylate, ethyl acrylate, tert-butyl acrylate, isobutyl acrylate, isodecyl acrylate, dihydrodicyclopentadienyl acrylate, ethyl diglycol acrylate, heptadecyl acrylate, 4-hydroxybutyl acrylate, 2-hydroxyethyl acrylate, hydroxyethylcaprolactone acrylate, polycaprolactone acrylate, hydroxypropyl acrylate, lauryl acrylate, stearyl acrylate, tert-butyl acrylate, 2-(2-ethoxy) ethyl acrylate, tetrahydrofurfuryl acrylate, 2-phenoxyethyl acrylate, ethoxylated 4-phenyl acrylate, trimethylcyclohexyl acrylate, octyldecyl acrylate, tridecyl acrylate, ethoxylated 4-nonylphenol acrylate, isobornyl acrylate, cyclic trimethylolpropane formal acrylate, ethoxylated 4-lauryl acrylate, polyester acrylate, stearyl acrylate, hyperbranched polyester acrylate, melamine acrylate, silicone acrylate, epoxy acrylate, and from bio-based methacrylates, wherein the bio-based methacrylates are selected from the group consisting of: methyl methacrylate, ethyl methacrylate, n-butyl methacrylate, isobutyl methacrylate, tert-butyl methacrylate, behenyl methacrylate, ehenylpolyethylene glycol methacrylate, cyclohexyl methacrylate, isodecyl methacrylate, 2-ethylhexyl methacrylate, lauryl methacrylate, stearyl methacrylate, stearylpolyethylene glycol methacrylate, isotridecyl methacrylate, ureidomethacrylate, tetrahydrofurfuryl methacrylate, phenoxyethyl methacrylate, 3,3,5-trimethylcyclohexanol methacrylate, isobornyl methacrylate, methoxypolyethylene glycol methacrylate, glycidyl methacrylate, hexylethyl methacrylate, glycerol formal methacrylate, lauryltetradecyl methacrylate, C17,4-methacrylate.

4. The molding according to claim 1, wherein the one or more polyfunctional biomonomer(s) is/are selected from bio-based acrylates, wherein the bio-based acrylates are selected from the group consisting of: 1,6-hexanediol diacrylate, polyethylene glycol diacrylate, tetraethylene glycol diacrylate, tripropylene glycol diacrylate, polybutadiene diacrylate, 3-methyl-1,5-pentanediol diacrylate, ethoxylated bisphenol A diacrylate, dipropylene glycol diacrylate, ethoxylated hexanediol diacrylate, 1,10-decanediol diacrylate, ester diol diacrylate, alkoxylated diacrylate, tricyclodecanedimethanol diacrylate, propoxylated neopentyl glycol diacrylate, pentaerythritol tetraacrylate, trimethylolpropane triacrylate, ditrimethylolpropane tetraacrylate, tris (2-hydroxyethyl) isocyanurate triacrylate, dipentaerythritol pentaacrylate, ethoxylated trimethylolpropane triacrylate, pentaerythritol triacrylate, propoxylated trimethylolpropane triacrylate, ethoxylated pentaerythritol tetraacrylate, propoxylated glyceryl triacrylate, aliphatic urethane diacrylate, aliphatic urethane hexaacrylate, aliphatic urethane triacrylate, aromatic urethane diacrylate, aromatic urethane triacrylate, aromatic urethane hexaacrylate, polyester hexaacrylate, epoxidized soybean oil diacrylate, and from bio-based polyfunctional methcrylates, wherein the bio-based polyfunctional methacrylates are selected from the group consisting of: triethylene glycol dimethacrylate, ethylene glycol dimethacrylate, polyethylene glycol dimethacrylate, 1,4-butanediol dimethacrylate, diethylene glycol dimethacrylate, 1,6-hexanediol dimethacrylate, 1,10-decanediol dimethacrylate, 1,3-butylene glycol dimethacrylate, ethoxylated bisphenol A dimethacrylate, tricyclodecanedimethanol dimethacrylate, trimethylolpropane trimethacrylate.

5. The molding according to claim 1, wherein the weight ratio of the two or more monofunctional and the one or more polyfunctional acrylates and methacrylates to the at least two polymer(s) or copolymer(s) is from 90:10 to 60:40.

6. The molding according to claim 1, wherein the inorganic filler particles are selected from SiO₂, Al₂O₃, TiO₂, ZrO₂, Fe₂O₃, ZnO, Cr₂O₅, carbon, metals and metal alloys.

7. The molding according to claim 1, wherein the inorganic filler particles have a particle size of from 0.010 to 8000 μm.

8. The molding according to claim 1, wherein the inorganic filler particles have an aspect ratio of length to width of from 1.0 to 1000.

9. The molding according to claim 1, wherein the molding is a kitchen sink, a shower base, a wash basin, a bathtub, a working surface or a floor, wall or ceiling panel.

10. The molding according to claim 1, wherein the polymerized material forming the molding is thermally stable in the range from −30 to 300° C.

11. The molding according to claim 2, wherein the weight ratio of the two or more monofunctional biomonomers to the one or more polyfunctional biomonomers is from 4:1 to 70:1.

12. The molding according to claim 11, wherein the weight ratio of the two or more monofunctional biomonomers to the one or more polyfunctional biomonomers is from 5:1 to 60:1.

13. The molding according to claim 5, wherein the weight ratio of the two or more monofunctional and the one or more polyfunctional acrylates and methacrylates to the at least two polymer(s) or copolymer(s) is from 85:15 to 70:30.

14. The molding according to claim 7, wherein the inorganic filler particles have a particle size of from 0.05 to 3000 μm.

15. The molding according to claim 14, wherein the inorganic filler particles have a particle size of from 0.1 to 1300 μm.
